(19) United States
(12) Patent Application Publication
(10) Pub. No.: US 2014/0092954 A1
(43) Pub. Date: Apr. 3, 2014

(54) Method and Apparatus for Encoding Video to Play at Multiple Speeds

(71) Applicant: Rockstar Consortium US LP, Plano, TX (US)

(72) Inventor: Martin Soukup, Ottawa (CA)

(21) Appl. No.: 14/093,479

(22) Filed: Dec. 1, 2013

Related U.S. Application Data
(63) Continuation of application No. PCT/CA11/50397, filed on Jun. 29, 2011.

(51) Int. Cl. H04N 7/26

(52) U.S. Cl. CPC H04N 19/0046
USPC 375/240.01

(57) ABSTRACT

Data that is to be transmitted to a viewer is encoded multiple times at multiple playback speeds. For example, a video advertisement may be encoded to play at normal speed, 4× normal speed, and 16× normal speed. Frames from the multiple encoded streams are combined to form a combined encoded stream that will play full motion video at each of the respective playback speeds. Thus, when a user elects to watch the video at a speed other than the slowest speed, the decoder will be able to decode the video at the selected speed to provide a full motion video output stream to the viewer at the selected playback speed.

### CROSS-REFERENCE TO RELATED APPLICATIONS

This application is a continuation of International Application PCT/US2011/050397, filed Jun. 29, 2011, the content of which is hereby incorporated herein by reference.

### TECHNICAL FIELD

The present invention relates to video encoding and, more particularly, to a method and apparatus for encoding video to play at multiple speeds.

### BACKGROUND

Data communication networks may include various computers, servers, nodes, routers, switches, bridges, hubs, proxies, and other network devices coupled together and configured to pass data to one another. These devices will be referred to herein as “network elements.” Data is communicated through the data communication network by passing protocol data units, such as data frames, packets, cells, or segments, between the network elements by utilizing one or more communication links. A particular protocol data unit may be handled by multiple network elements and cross multiple communication links as it travels between its source and its destination over the network.

Data is often encoded for transmission on a communication network to enable larger amounts of data to be transmitted on the network. The Motion Picture Experts Group (MPEG) has published multiple standards which may be used to encode data. Of these standards, MPEG-2 has been widely adopted for transport of video and audio in broadcast quality television. Other MPEG standards, such as MPEG-4, also exist and are in use for encoding video. Encoded data will be packetized into protocol data units for transportation on the communication network. When the data protocol data units are received, the encoded data is extracted from the protocol data units, and decoded to recreate the video stream or other original data format.

Content providers frequently include advertisements in an encoded audio/video stream. Advertisers pay the content providers to include the advertisements, which helps to subsidize the cost of providing the content on the network. However, end viewers often are less interested in viewing advertisements and, when possible, will fast forward through the advertisements to avoid them. For example, an end viewer may record a program using a Personal Video Recorder (PVR) or a Digital Video Recorder (DVR) and fast forward past advertisements to reduce the amount of time required to view the program. This, of course, reduces the value to the advertiser and hence reduces the amount the advertiser is willing to pay to the content provider for inclusion of the ads.

When a viewer fast-forwards through a recorded advertisement, snapshots of the advertisement become visible on the viewer's screen. This allows the viewer to discern when the advertisement is over and when the content has resumed, so that the viewer can once again resume watching the program at normal speed. Content providers understand this behavior and have taken steps to allow at least some information associated with the advertisement to be provided to the viewer. For example, the British Broadcasting Company (BBC) in the United Kingdom has taken the approach of airing advertisements that include a static image with a voice-over. Since the advertisement has a static image, the same image will be visible regardless of the speed at which the user fast-forwards through the advertisement. While this provides some level of advertising presentation to the viewer while the viewer is fast-forwarding through the advertisement, viewers watching the advertisement at normal speed will be less engaged by a static image than they would by full motion video.

### SUMMARY OF THE INVENTION

The following Summary and the Abstract set forth at the end of this application are provided herein to introduce some concepts discussed in the Detailed Description below. The Summary and Abstract sections are not comprehensive and are not intended to delineate the scope of protectable subject matter which is set forth by the claims presented below.

Data that is to be transmitted to a viewer is encoded multiple times at multiple playback speeds. For example, a video advertisement may be encoded to play at normal speed, 4× normal speed, and 16× normal speed. Frames from the multiple encoded streams are then combined to form a combined encoded stream that will play full motion video at each of the respective playback speeds. Thus, when a user elects to watch the video at a speed other than the slowest speed, the decoder will be able to decode the video at the selected speed to provide a full motion video output stream to the viewer at the selected playback speed.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of a reference network;

FIG. 2 is a functional block diagram of a decoder according to an embodiment of the invention;

FIGS. 3-4 are flow charts showing processes that may be implemented according to embodiments of the invention;

FIG. 5 graphically illustrates multiple encodings of a common video stream at multiple playback speeds;

FIG. 6 graphically illustrates combining the multiple encodings of FIG. 5 into a combined encoded video stream capable of being decoded at each of the multiple playback speeds; and

FIG. 7 is a block diagram of an encoder configured to multiply encode a common video stream at multiple playback speeds, and create a combined encoded video stream capable of being decoded at each of the multiple playback speeds.

### DETAILED DESCRIPTION

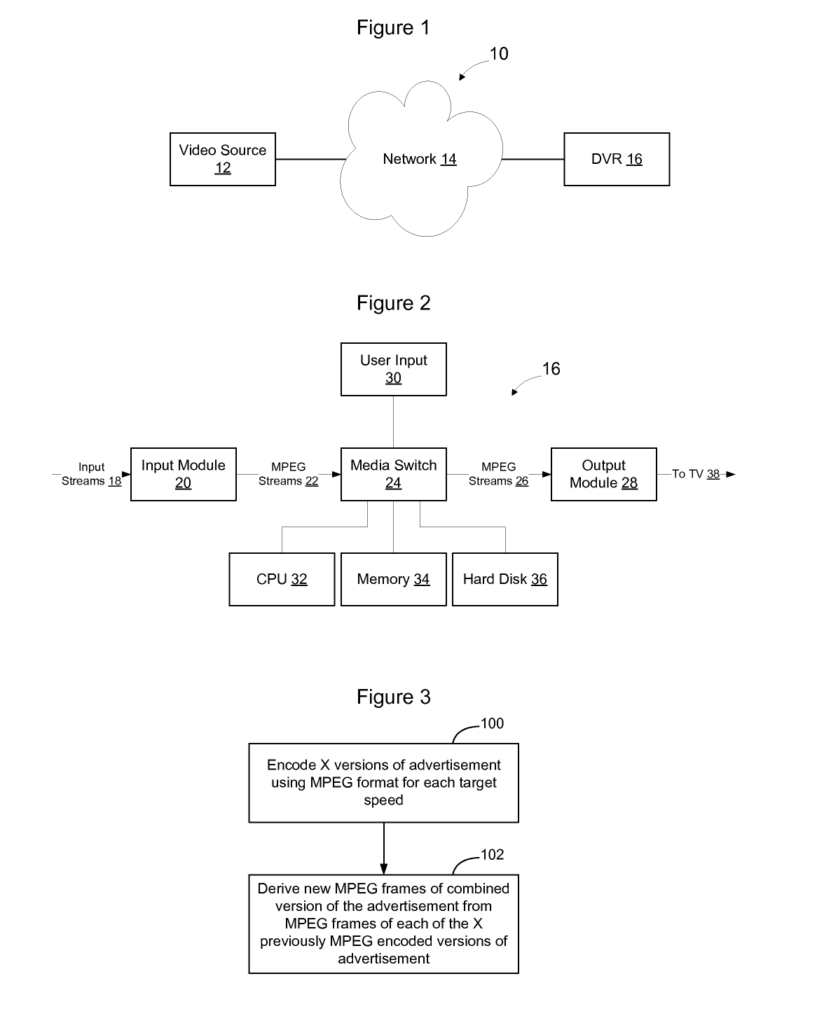

FIG. 1 shows a system 10, in which video from a video source 12 is transmitted over network 14 to an end user device such as a Digital Video Recorder or Personal Video Recorder 16. In the following description it will be assumed that the video source 12 encodes video for transmission on the network 14 using an encoding scheme such as one of the published encoding processes specified by the Motion Picture Experts Group (MPEG). For example, the video may be encoded using MPEG-2, MPEG-4, or another one of the MPEG standards. Other video compression processes may be used as well.

Video compression may be implemented using many different compression algorithms, but generally video compression processes generally use three basic frame types, which are commonly referred to as I-frames, P-frames, and B-frames. In the field of video compression, a video frame is compressed using different algorithms with different advantages and disadvantages, centered mainly around amount of data compression. These different algorithms for video frames are called picture types or frame types. The three major picture types used in the different video algorithms are I, P and B.

I-frames are the least compressible, but don't require other video frames to decode. These are often referred to as key-frames since they contain information in the form of pixel data to describe a picture of the video at an instant in time. An I-frame is an ‘Intra-coded picture’, which, in effect, is a fully-specified picture similar to a conventional static image file. In an I-frame, pictures are coded without reference to any pictures except themselves. I-frames may be generated by an encoder to create a random access point (to allow a decoder to start decoding properly from scratch at that picture location). Likewise, I frames may be generated when differentiating image details prohibit generation of effective P or B frames. However, I-frames typically require more bits to encode than other picture types.

Often, I-frames are used for random access and are used as references for the decoding of other pictures. Intra refresh periods of a half-second are common in applications such as digital television broadcast and DVD storage. Longer refresh periods may be used in other applications. For example, in videoconferencing systems it is common to send I frames very infrequently.

P-frames and B-frames are generally used to transmit changes to the image rather than the entire image. Since these types of frames generally hold only part of the image information, they accordingly require less space to store than an I-frame. Use of P and B frames thus improves video compression rate. A P-frame is a forward-predicted frame and contains only the changes in the image from the previous frame. For example, in a scene where a car moves across a stationary background, only the car's movements need to be encoded. The encoder does not need to store the unchanging background pixels in the P-frame, thus saving space. P-frames are also known as delta-frames. A B-frame (‘Bi-predictive picture’) saves even more space by using differences between the current frame and both the preceding and following frames to specify its content.

A P-frame requires the decoder to decode another frame in order to be decoded. P-frames may contain both image data and motion vector displacements and combinations of the two. Likewise, P-frames can reference previous pictures in decoding order. Some encoding schemes, such as MPEG-2, use only one previously-decoded picture as a reference during decoding, and require that picture to also precede the P picture in display order. Other encoding schemes, such as H.264, can use multiple previously-decoded pictures as references during decoding, and can have any arbitrary display-order relationship relative to the picture(s) used for its prediction. An advantage from a bandwidth perspective, is that P-frames typically require fewer bits for encoding than I pictures require.

B-frames, like P-frames, require the prior decoding of some other picture(s) in order to be decoded. Likewise, B-frames may contain both image data and motion vector displacements and combinations of the two. Further, B-frames may include some prediction modes that form a prediction of a motion region (e.g., a macroblock or a smaller area) by averaging the predictions obtained using two different previously-decoded reference regions.

Different encoding standards provide restrictions on how B-frames may be used. In MPEG-2, for example, B-frames are never used as references for the prediction of other pictures. As a result, a lower quality encoding (resulting in the use of fewer bits than would otherwise be the case) can be used for such B pictures because the loss of detail will not harm the prediction quality for subsequent pictures. MPEG-2 also uses exactly two previously-decoded pictures as references during decoding, and require one of those pictures to precede the B picture in display order and the other one to follow it.

H.264, by contrast, allows B-frames to be used as references for decoding other pictures. Additionally, B-frames can use one, two, or more than two previously-decoded pictures as references during decoding, and can have any arbitrary display-order relationship relative to the picture(s) used for its prediction. An advantage of using B-frames is that they typically require fewer bits for encoding than either I or P frames require.

In one embodiment, video source 12 encodes video for transmission and transmits the encoded video on network 14. The video may be encoded using the I-frames, P-frames, and B-frames described above. When DVR 16 receives the video, it will decode the video and either cause the video to be displayed, discarded, or stored to be displayed at a later time. FIG. 2 shows one example system that may be utilized to implement DVR 16. Encoding and decoding video is well known, and multiple standards have been developed describing different ways of encoding and decoding video.

As shown in FIG. 2, an example DVR includes has an input module 20, Media Switch 24, and an output module 28. The input module 20 takes television (TV) input streams such as Digital Satellite System (DSS), Digital Broadcast Services (DBS), or Advanced Television Standards Committee (ATSC) and produces MPEG streams 22. DBS, DSS and ATSC are based on standards which utilize Moving Pictures Experts Group 2 (MPEG-2) Transport. MPEG2 Transport is a standard for formatting the digital data stream from the TV source transmitter so that a TV receiver can disassemble the input stream to find programs in the multiplexed signal.

The input module 20 produces MPEG streams 22. An MPEG2 transport multiplex supports multiple programs in the same broadcast channel, with multiple video and audio feeds and private data. The input module 20 tunes the channel to a particular program, extracts a specific MPEG program out of it, and feeds it to the rest of the system.

The media switch 24 mediates between a microprocessor CPU 32, memory 34, and hard disk or storage device 36. Input streams are converted to MPEG stream 22 by input module 20 and sent to the media switch 24. The media switch 24 buffers selected MPEG streams 22 into memory 34 if the user is watching the MPEG stream 22 in real time, or will cause MPEG stream 22 to be written to hard disk 36 if the user is not watching the MPEG stream in real time. The media switch will also cause stored video to be read out of memory 34 or hard disk 36 to allow video to be stored and then played at a subsequent point in time.

The output module 28 takes MPEG streams 26 as input and produces an analog TV signal according to the NTSC, PAL, or other required TV standards. Where the television attached to the DVR is capable of receiving digital signals, the output module 28 will output digital signals to the television monitor. The output module 28 contains an MPEG decoder, on-screen display (OSD) generator, (optionally analog TV encoder), and audio logic. The OSD generator allows the program logic to supply images which will be overlayed on top of the resulting analog TV signal.

A user may control operation of the media switch to select which MPEG stream 22 is passed as MPEG stream 26 to output module 28 to be displayed, and which of the MPEG streams 22 is recorded on hard disk 36. Example user controls include remote controls with buttons that allow the user to select how the media switch is operating. The user may also use the user input 30 to control a rate at which stored media is output from the hard disk 36. For example, the user may elect to pause a video stream, play the video stream in slow motion, reverse the video stream, or to fast-forward the video stream.

According to an embodiment of the invention, video in one of the input streams 18 is encoded to be played at a plurality of speeds, such as at normal speed (1×), four times normal speed (4×), and sixteen times normal speed (16×). The video encoding is performed such that full motion video will be visible to the end viewer at each of the selected plurality of speeds. This may be particularly advantageous, for example, in an advertising context where the entity paying for an advertisement to be included in the video stream may want the advertisement to reach viewers who elect to fast-forward through advertisements. When the combined multiply encoded video stream is received at the input module, it will be extracted as one of the MPEG streams 22 and passed to the media switch. If the user is watching the MPEG stream in real time, the media switch will buffer the video to memory 34 and pass the video via MPEG stream 26 to output module 28. If the user has elected to store the video for subsequent viewing, the media switch 24 will write the video to hard disk 36. When the user later causes the media switch to output the combined multiply encoded video stream from the hard disk 36, the video will be provided to output module 28. If the user elects to fast-forward the video being read out of memory 34 or disk 36 at one of the original encoding rates, the video that is presented to the end user will be provided in full motion format.

FIG. 3 shows an overview of an example process that may be used to encode video to be played at multiple speeds. As shown in FIG. 3, initially the video stream is encoded using a standard MPEG or other standard video encoding process. The video stream is encoded multiple times such that a separate encoded video stream is created for each of the several speeds at which the video is to be played. (100) The speeds at which the video is encoded are referred to herein as “target speeds”.

Once the video has been encoded at each target speed, the multiple encoded streams are combined into a single encoded video stream. (102) Specifically, new MPEG frames of the combined version of the video are derived from each of the previously encoded versions of the video such that the resultant encoded video may be played at each of the target speeds. An example of how video may be combined in this nature will be described below using an example in which there are three target speeds (1×, 4×, and 16×). The method is extensible beyond three speeds. However, since the process of combining the multiple encoded versions of the video requires some of the frames of the lowest speed encoding to be dropped, preferably the number of speeds is kept to a relatively low number to enable the normal rate video to retain a relatively high quality image.

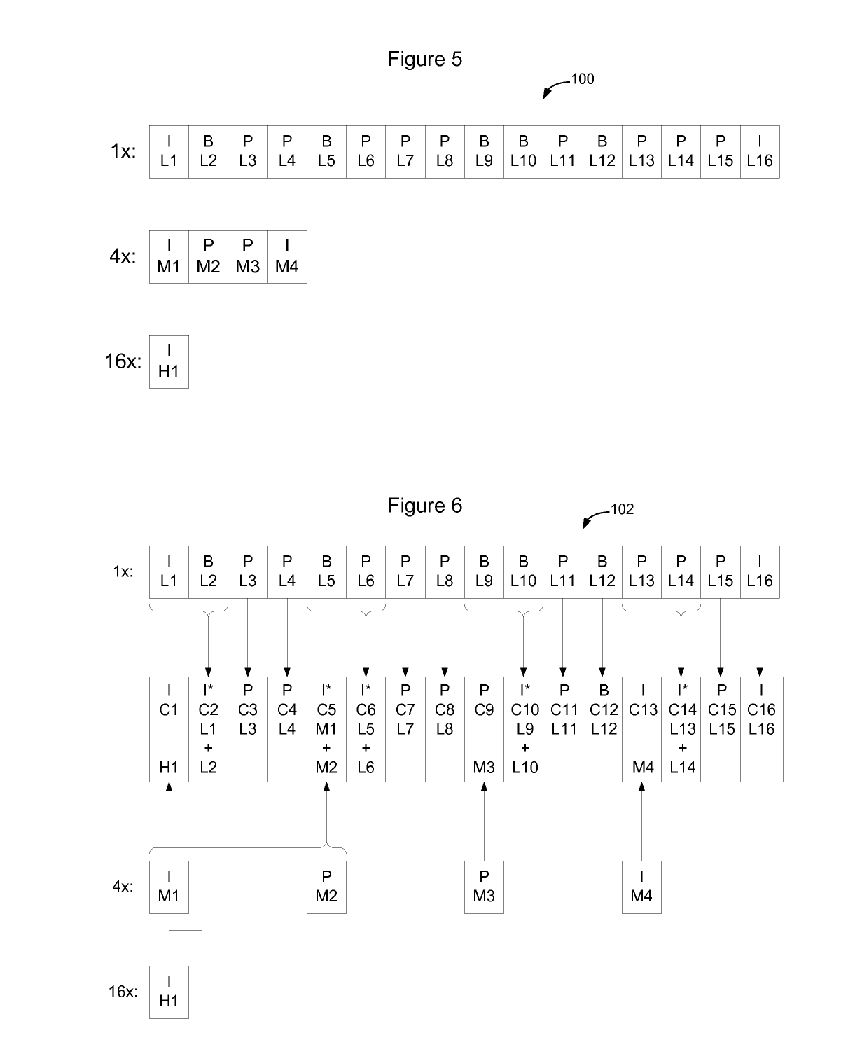

FIG. 5 shows an example video stream that has been encoded three times—once at normal speed (1×), once at four times speed (4×) and once at sixteen times normal speed (16×). In FIG. 1, each of the low speed frames has been labeled using a designation “L” which stands for Low-speed. These frames are numbered L1-L16 and represent the normal speed encoding of the video. As shown in FIG. 5, the 1× target encoding includes Intra-coded frames (I-frames), Predicted encoded frames (P-frames) and Bi-directionally predicted encoded frames (B-frames).

As shown in FIG. 5, the video is also encoded, in this example, at a 4× target speed. This will allow a viewer to watch the video at four times normal speed, for example, when fast-forwarding through an advertisement. The frames of the 4× encoded version are labeled using a designation “M” for “mid-level” speed, and are labeled M1-M4. The M designation, in the context of a video that is encoded at three different speeds, represents the intermediate speed between the slowest speed video (1×) and highest speed video (16×). In the illustrated example the mid-level target speed is 4 times faster than the low speed video. As shown in FIG. 5, the 4× target encoding also includes Intra-coded frames (I-frames) and Predicted encoded frames (P-frames). The illustrated example does not show the use of Bi-directionally predicted encoded frames (B-frames) but such frames may also be included in the 4× target encoding stream depending on the implementation.

The video is also encoded at the fastest target video stream which, in the illustrated example is at sixteen times the lowest speed (16×). The frames of this video stream are designated using the letter H, which stands for High-speed. High speed encoded frames may include I, P and B frames depending on the embodiment.

Once the video has been encoded at the several target speeds, or as the video is being encoded at the several target speeds, the frames of the several encoded versions of the video are used to derive new frames that will allow the several target speed versions to be combined into a single encoded stream of frames that may be played back at each of the target speeds. FIG. 6 shows graphically how the frames of the originally encoded video at the several target speeds are used to derive new frames for the combined encoded video stream.

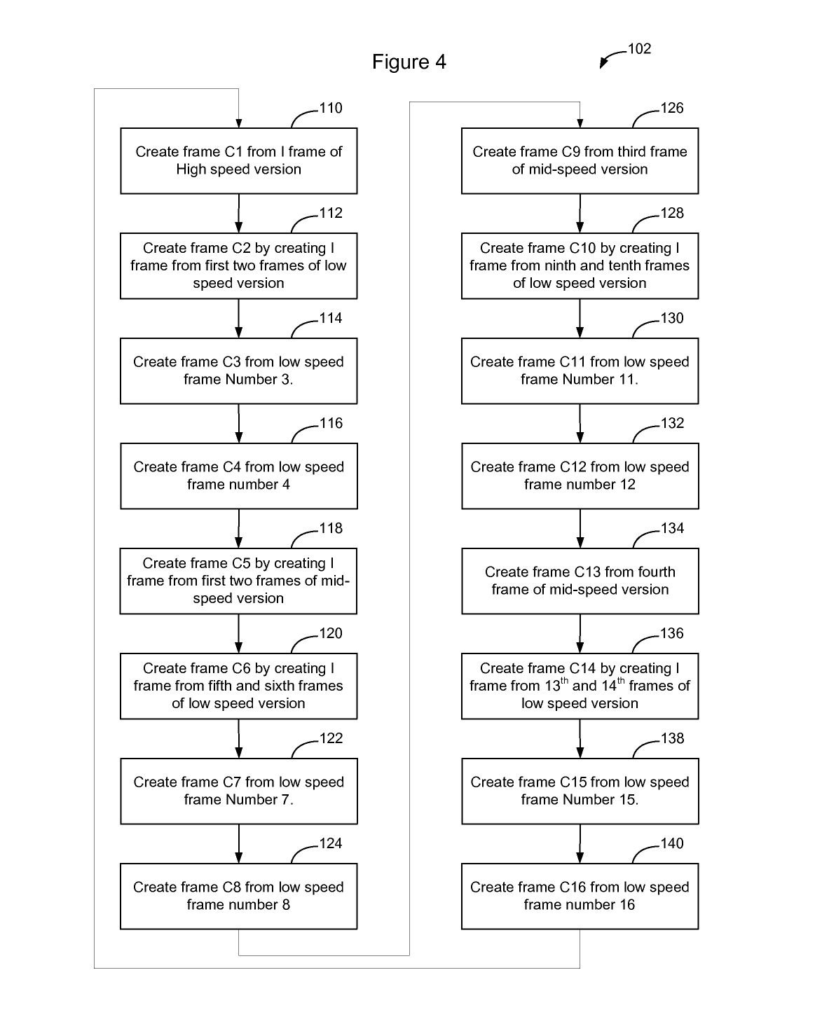

FIG. 4 shows the steps of an example process that may be used to derive the frames for the combined encoded video stream. The frames of the resultant video stream shown in FIG. 6 are designated frames C1-C16. In this context, the designation “C” stands for Combined, since the resultant combined encoded video stream may be played at any one of the target video encoding rates to reproduce the video at the selected target encoding rate. Thus, for example, if three target video encoding rates 1×, 4×, and 16× are used to create a single combined encoded video stream C1-16, the resultant combined encoded video stream will be able to be played at 1×, 4×, and 16×. Additionally, although the combined encoded video stream does not provide 100% fidelity to the original video streams that were used to create it (some of the original frames are required to be dropped), the resultant video stream provides a close approximation to the target streams so that the video contained in the combined encoded video stream may be adequately viewed at each of the target rates.

As shown in FIG. 6, the combined encoded video stream is formed of I-frames, P-frames, and B-frames in a manner similar to each of the target video frames. To allow the combined encoded video stream to be played at multiple rates, the frames of the combined encoded video stream are derived from the frames of the target streams such that the frames at the selected positions contain sufficient information to encode the video stream at that point in time. Thus, for example, as shown in FIG. 6, frames C1-C16 should allow the decoder to decode the same set of images that it would decode by decoding the low-speed frames L1-L16. Additionally, the frames at positions C1, C5, C9, and C13 should allow the decoder to decode the same image that it would decode by decoding frames M1, M2, M3, and M4. The reason behind this is that the decoder, when fast forwarding through the video at 4× speed, will read every 4^{th} frame. Normally, the decoder would display an image any time it read an I frame which may be sporadic and not provide a consistent/fluid image. By creating the frames at the 4× positions to recreate the image encoded as the 4× encoded version of the original video (M1-M4) a decoder can decode the combined encoded video stream to provide fluid video while the user fast-forwards the video at 4× speed. Likewise, frame C1 should allow the decoder to decode the same image that it would decode by decoding the high-speed encoded series, e.g. H1. This allows the decoder to provide fluid video at the high speed (16×) speed as well.

One way in which the combined video stream may be created will be described in connection with FIGS. 4 and 6. In this example, the highest encoded speed to be replayed is 16× normal speed. Accordingly, in this example the combined sequence of frames will have an I-frame at every 16th position. Thus, as shown in FIG. 6, frame C1 is an I frame and is based on the I-frame from the high speed version. Coincidentally, since the low and middle speed versions will also have the same I-frame at that position, the first frame of the combined sequence (C1) will be the same as the first frame of the middle speed version M1 as well as the same as the first frame of the low speed (normal speed) version L1. In FIG. 4, box 110 shows creation of the first combined frame C1.

The second combined frame C2 will then be created by creating a new I-frame from the first two frames of the low speed version (112). Specifically, frames L1 (an I-frame in this example) and frame L2 (a bi-directionally predicted frame in this example) are used to create frame C2. Since this encoding rates are 1×, 4×, and 16×, only the 1× replay rate will use combined frames C2-C4. By combining the information from both frames L1 and L2 into a new I-frame, the low speed version (1× version) will be able to recreate the video content at C2 with fidelity.

The third frame of the combined version C3 is then created from the third low-speed frame L3 (114) and likewise the fourth frame of the combined version C4 is created from the fourth low-speed frame L4 (116).

Combined frame C5 will be read when the video is read at both the low speed (1×) rate and at the middle speed rate (4×). Accordingly, frame M2 of middle-speed rate video is used to create combined frame C5 (118). In the example shown in FIG. 6, the first two frames of the Mid-speed video are used to create frame C5 (C5=M1+M2).

Combined frame C6 is then created as an I-frame from original frames L5 and L6 of the low speed version. (120). This allows the video at combined frame 6 to match the video as it would exist in the low speed version. Accordingly, subsequent B-frames and P-frames of the original low speed version (frames L7 and L8) may be used as the combined frames C7 and C8. (122, 124).

The ninth frame of the combined frame C9 will be read by both the mid-speed (4×) and low-speed (1×) replay rates. This frame C9 is created from Mid-speed frame M3 which, in the illustrated example is a P-frame (126). As noted above, P-frames are forward predicted frames which encode changes to the picture. Mid-speed P-frame M3 references I frame M1 in the original encoded version. However, since the combined encoded version has an I-frame at C5 (which effectively causes an I-frame to be created for position M2 in the 4× rate), the P-frame located at position C9, when read at the mid-speed 4× replay rate, will contain changes relative to the I-frame at position C5 rather than changes relative to the original I-frame M1. Hence, the P-frame created for combined rate frame C9 is modified from the original frame M3, so that it references the new I-frame (C5) that was created to replace frame M2 rather than referring all the way back to the state of the encoder at frame M1.

When frame C9 is read at the low-speed rate (1×) the changes contained in the frame will be interpreted as relative to the most recent I-frame which, in this case, is the I-frame at position C6. Optionally, frame C9 may be implemented using an I-frame.

Frame C10 of the combined encoded version is then created by creating an I-frame from the 9^{th} and 10^{th} frames (L9+L10) of the low speed 1× version (128). Low speed frame L11 is then used as combined frame C11 (130) and low speed frame L12 is used as combined frame C12 (132).

Combined frame C13 will be read during both low-speed replay (1×) and during mid-speed replay (4×). Accordingly, frame C13 is created from mid-speed frame M4 which, in the illustrated example, is an I-frame. Accordingly, frame C13 is created as an I-frame from I-frame M4 (134).

Frame C14 is created as a new I-frame to incorporate the changes contained in original P-frames L13 and L14 (136). Combined frames C15 and C16 are then taken directly from low speed encoded frames L15 and L16 (138, 140).

This process iterates for each group of 16 low speed frames, 4 mid-speed frames, and 1 high-speed frame, to create a combined encoded video stream that may be read back at three different rates. In this example the rates selected were 1×, 4×, and 16×. The method is extensible to include additional replay rates or to use different replay rates. According to an embodiment, the frames of the combined stream are created such that frames selected at multiple replay rates will be able to be decoded to provide contiguous output video at the selected rate.

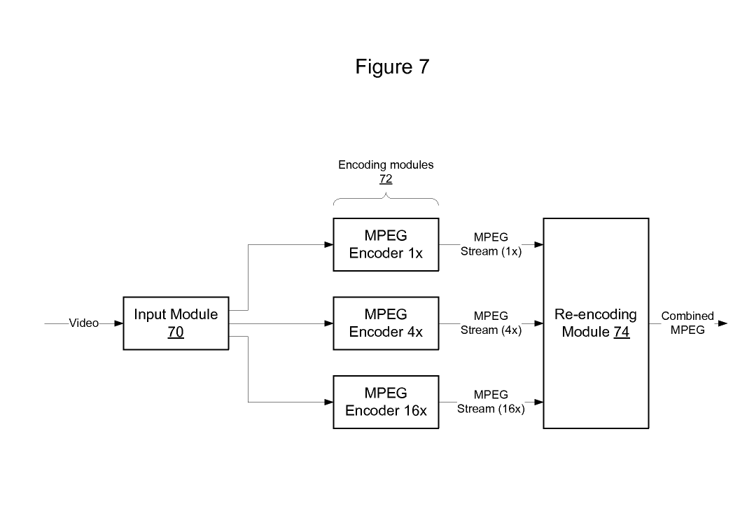

FIG. 7 shows an example system that may be used to encode video multiple times for playback at multiple rates, and then reencode a combined output video stream based on these encodings so that a single video stream may be used to output video at multiple playback speeds. In the example shown in FIG. 7, video to be encoded is received at an input module 70 and passed to each of the encoding modules 72. The encoding modules create different versions of the output video which are designed to be played at different speeds. In the illustrated example, the encoding modules are designed to create MPEG at normal playback speed, 4× replay speed, and 16× replay speed. If other replay speeds are selected, the other encoding modules may be used. Likewise if a video encoding scheme other than MPEG is used, other encoding modules may be used.

The output streams from these encoding modules are passed to a reencoding module 74. The reencoding module 74 combines the multiple encodings of the same original Video, to produce a combined output stream that may be played back at each of the speeds at which the video was encoded. Stated another way, if the video received by the input module is encoded at three different speeds, the reencoding module uses the encodings at each of these speeds to create a combined encoding that is also able to be decoded at each of the respective three different speeds. The output combined encoded video signal is transported to the viewer. If the viewer opts to store the combined encoded video signal (e.g. in memory 34 or on hard disck 36) and fast-forwards over a portion of the encoded video at one of the selected speeds (e.g. at 4× or 16×), use of the combined encoded video signal will allow the decoder to smoothly decode the video to closely resemble the video as it was encoded by a respective one of the video encoders 72.

The functions described above may be implemented as a set of program instructions that are stored in a computer readable memory and executed on one or more processors on a computer platform. However, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, a state machine, or any other device including any combination thereof. Programmable logic can be fixed temporarily or permanently in a tangible medium such as a read-only memory chip, a computer memory, a disk, or other storage medium. All such embodiments are intended to fall within the scope of the present invention.

A computer program product may be compiled and processed as a module. In programming, a module may be organized as a collection of routines and data structures that perform a particular task or implement a particular abstract data type. Modules are typically composed of two portions, an interface and an implementation. The interface lists the constants, data types, variables, and routines that can be accessed by other routines or modules. The implementation may be private in that it is only accessible by the module. The implementation also contains source code that actually implements the routines in the module. Thus, a program product can be formed from a series of interconnected modules or instruction modules dedicated to working together to accomplish a particular task.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense.

What is claimed is:

1. A non-transitory tangible computer readable storage medium having stored thereon a computer program product for implementing a video encoder, the computer program product comprising data and instructions which, when executed by a processor, cause the processor to perform a method comprising the steps of:
encoding a video stream using a video encoding format multiple times, at multiple target rates, to produce multiple encodings of the video stream;
combining the multiple encodings of the video stream into a combined encoded video stream capable of being read by a decoder at each of the multiple target rates to enable the decoder to recreate full motion video from the combined encoded video stream at each of the target rates.

2. The computer program product of claim 1, wherein the video encoding format is one of the MPEG formats.

3. The computer program product of claim 2, wherein the same video encoding format is used to encode the video stream at each of the multiple target rates.

4. The computer program product of claim 1, wherein the multiple target rates are normal replay rate (1×), four times replay rate (4×), and sixteen times replay rate (16×).

5. The computer program product of claim 1, wherein each of the multiple encodings of the video stream is playable to provide full motion video at the target rate, and wherein the combined encoded video stream is also playable to provide full motion video at each of the target rates.

6. The computer program product of claim 1, wherein the step of encoding the video stream multiple times results in at least three ordered sequences of frames, each of the at least three ordered sequences of frames representing the video stream at each of the target rates.

7. The computer program product of claim 6, wherein each of the ordered sequences of frames provides full motion video at the target rate.

8. The computer program product of claim 6, wherein a first of the target rates is a normal replay rate (1×), a second of the target rates is a four times replay rate (4×), and a third of the target rates is sixteen times replay rate (16×).

9. The computer program product of claim 8, wherein a first ordered sequence associated with the normal replay rate contains segments of sixteen frames, the first ordered sequence including sixteen frames in each segment to enable full motion video to be reproduced at the normal replay rate.

10. The computer program product of claim 9, wherein a second ordered sequence associated with the four times replay rate (4×) contains four frames in each segment corresponding to the state of an encoder at a first, fifth, ninth, and thirteenth frames of a corresponding segment in the first ordered sequence.

11. The computer program product of claim 10, wherein the step of combining the multiple encodings causes an I frame to be used to represent a state of the video at a first frame of each segment of the combined encoded video stream.

12. The computer program product of claim 11, wherein the step of combining the multiple encodings causes the frames at each of the first, fifth, ninth, and thirteenth frames of a segment of the combined encoded video stream to correspond to the first, fifth, ninth, and thirteenth frames of a corresponding segment in the second ordered sequence.

13. The computer program product of claim 1, wherein the frames are I-frames, P-frames, and B-frames.

14. A method of displaying information to a viewer, the method comprising the step of using multiply encoded video to provide smooth video playback when the multiply encoded video is read to provide output video at multiple target speeds.

15. A video stream, comprising:
an ordered sequence of frames containing information describing full motion video when played at normal speed and when played at each of a plurality of target speeds, each of said target speeds being higher than the normal speed.

16. The video stream of claim 15, wherein the target speeds are 4× and 16×.

17. The video stream of claim 15, wherein the frames are I-frames, P-frames, and B-frames.

18. The video stream of claim 15, wherein the ordered sequence of frames are created from multiple encodings at the target speeds of a reference video.

19. The video stream of claim 15, wherein the ordered sequence is grouped according to the highest target speed into segments.

20. The video stream of claim 19, wherein a first frame of each segment is an I frame corresponding to a view of the video as encoded at that frame at the highest target speed.

21. The video stream of claim 19, wherein a second frame of each segment is an I frame created from the first two frames frame of a corresponding segment of the lowest target speed encoding.

22. The video stream of claim 21, wherein the third and fourth frames of each segment are created to correspond to the third and fourth frames respectively of the corresponding segment of the lowest target speed encoding.

23. The video stream of claim 15, wherein a fifth frame of each segment is created to correspond to the second frame of a middle target speed encoding.
